(19) United States
(12) Patent Application Publication
(10) Pub. No.: US 2024/0404205 A1
(43) Pub. Date: Dec. 5, 2024

(54) INFORMATION PROCESSING APPARATUS

(71) Applicant: CANON KABUSHIKI KAISHA, Tokyo (JP)

(72) Inventor: HIDETAKA TSUCHIYA, Tokyo (JP)

(21) Appl. No.: 18/672,266

(22) Filed: May 23, 2024

(30) Foreign Application Priority Data
May 29, 2023 (JP) 2023-087774

(51) Int. Cl. G06T 19/00; G06F 3/01

(52) U.S. Cl. CPC G06T 19/00; G06F 3/011; G06T 2219/024

(57) ABSTRACT

An information processing apparatus according to the present invention includes: a processor; and a memory storing a program which, when executed by the processor, causes the processor to detect virtual contact of a second user with respect to a first user in a three-dimensional space that is a virtual space or a mixed reality space; and perform control such that, in a case where the virtual contact has occurred, the first user is notified of information about a position of the contact.

### BACKGROUND OF THE INVENTION

### Field of the Invention

The present invention relates to an information processing apparatus. In particular, the present invention relates to a technique for supporting communication between users in a virtual space or mixed reality space.

### Description of the Related Art

There is known virtual reality (hereinafter, referred to as VR) technology for generating, by computers or the like, an environment in which users can interact with virtual objects. As a technology for merging the real world with images in a virtual world in real time, mixed reality (hereinafter, referred to as MR) technology and augmented reality (hereinafter, referred to as AR) technology are also known. A goggle-type or glasses-type display device called a head mounted display (hereinafter, referred to as an HMD) is commonly used for viewing video using these technologies (hereinafter, referred to as XR technology). The HMD includes, for example, two displays positioned to align with the positions of the left and right eyes. The HMD including a camera for acquiring external images on its front surface has also been proposed.

There has been proposed a technique that enables communication between users by using characters (hereinafter, referred to as avatars) representing the users in a virtual space (hereinafter, referred to as a VR space) or a mixed reality space (hereinafter, referred to as an MR space). The avatar can be operated by using a controller or by motion tracking.

Japanese Patent Application Publication No. 2020-80152 discloses a technique for giving a user feedback about contact with a virtual object. Japanese Patent Application Publication No. 2001-236291 discloses a technique in which contact between avatars in a VR space serves as a trigger to start a chat between users. Japanese Patent Application Publication No. 2019-61434 discloses a technique in which, in response to an event in which an avatar of a user who is not wearing an HMD has been shaken by another avatar in a VR space, notification is provided to a terminal of the user who is not wearing the HMD.

However, with the techniques disclosed in Japanese Patent Application Publication No. 2020-80152, Japanese Patent Application Publication No. 2001-236291, and Japanese Patent Application Publication No. 2019-61434, the contact between avatars cannot be utilized as a sufficient communication tool. The technique disclosed in Japanese Patent Application Publication No. 2020-80152 is for giving a user feedback about the fact that the user has actively come into contact with the virtual object. Even when the technique disclosed in Japanese Patent Application Publication No. 2020-80152 is used, while the feedback can be given to the user (contacting person) of the avatar who has actively come into contact with another avatar, no notification is given to the user (contacted person) of the avatar who has been touched by the other avatar (contacting person). Therefore, the contacted person cannot recognize the contact. In the technique disclosed in Japanese Patent Application Publication No. 2001-236291, the contact between avatars is merely utilized for starting a chat. In the technique disclosed in Japanese Patent Application Publication No. 2019-61434, the contact between avatars (an avatar shaking another avatar) is merely utilized for giving notification to a terminal of the user who is not wearing the HMD. As described above, in the techniques disclosed in Japanese Patent Application Publication No. 2001-236291 and Japanese Patent Application Publication No. 2019-61434, the contact between avatars is not utilized in the same manner as contact in the real world, and thus, the contact between avatars is not sufficient as a communication tool.

### SUMMARY OF THE INVENTION

The present invention provides a technique to enable to utilize virtual contact between users, such as contact between avatars, as a sufficient communication tool.

The present invention in its first aspect provides an information processing apparatus including: a processor; and a memory storing a program which, when executed by the processor, causes the processor to detect virtual contact of a second user with respect to a first user in a three-dimensional space that is a virtual space or a mixed reality space; and perform control such that, in a case where the virtual contact has occurred, the first user is notified of information about a position of the contact.

The present invention in its second aspect provides a control method of an information processing apparatus, the control method including: detecting virtual contact of a second user with respect to a first user in a three-dimensional space that is a virtual space or a mixed reality space; and performing control such that, in a case where the virtual contact has occurred, the first user is notified of information about a position of the contact.

The present invention in its third aspect provides a non-transitory computer readable medium that stores a program, wherein the program causes a computer to execute a control method of an information processing apparatus, the control method including: detecting virtual contact of a second user with respect to a first user in a three-dimensional space that is a virtual space or a mixed reality space; and performing control such that, in a case where the virtual contact has occurred, the first user is notified of information about a position of the contact.

Further features of the present invention will become apparent from the following description of exemplary embodiments with reference to the attached drawings.

### BRIEF DESCRIPTION OF THE DRAWINGS

FIG. 1 is an external view of a head mounted display (hereinafter, referred to as an HMD);

FIG. 2 is a block diagram of the HMD;

FIGS. 3A and 3B are schematic diagrams illustrating contact information;

FIG. 4 is a flowchart of a contact notification process;

FIG. 5 is a flowchart of a contact detection process; and

FIG. 6 is a flowchart of a notification determination process.

### DESCRIPTION OF THE EMBODIMENTS

Hereinafter, an Embodiment of the present invention will be described in detail with reference to the accompanying drawings.

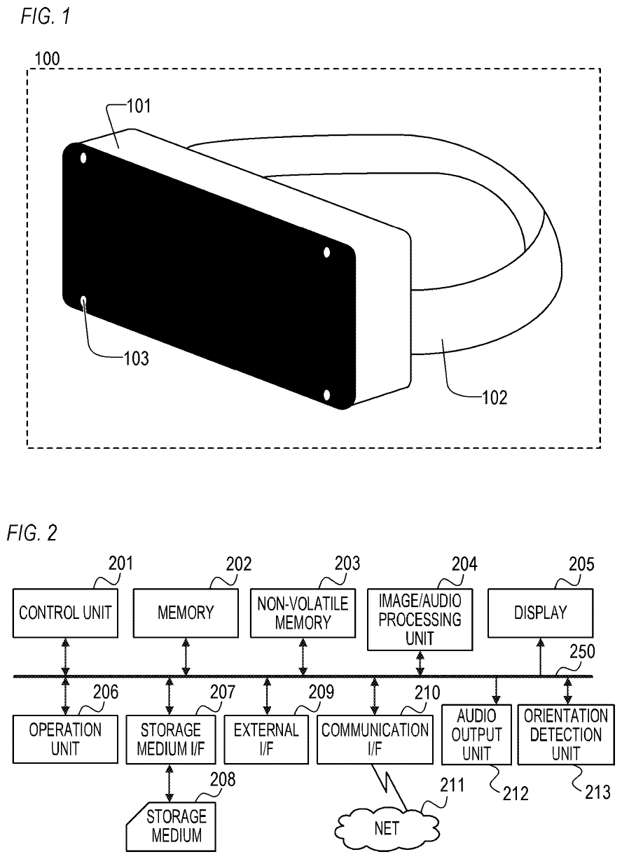

FIG. 1 is an external view illustrating the appearance of a head-mounted display (hereinafter, an HMD) 100 as an example of an information processing apparatus to which the present invention is applicable. The HMD 100 is a goggle-type display apparatus to be worn on the head of a user. A main body unit 101 includes various types of hardware, which will be described below. For example, the main body unit 101 includes a display on the back side of the main body unit 101. The user who is wearing the HMD 100 can view various contents displayed on the display. A strap 102 is used to secure the main body unit 101 to the head of the user. A camera 103 captures images of the surroundings (for example, the front side) of the HMD 100.

The HMD 100 can provide the user with a mixed reality space (hereinafter, referred to as an MR space) by displaying, on the display, video captured by the camera 103 or a video based on the captured video. The HMD 100 can also provide the user with a virtual space (hereinafter, referred to as a VR space) by displaying, on the display, video unrelated to the video captured by the camera 103. The HMD 100 can display a character (hereinafter, referred to as an avatar) representing a user (the user of the HMD 100 or a user of an HMD different from the HMD 100) as the user in the VR space and the MR space. The HMD 100 may display an image of the user himself/herself captured by the camera 103 as the user of the HMD 100, instead of the avatar.

Examples of the method for providing the user with the MR space include a video see-through method and an optical see-through method. In the video see-through method, video of the real space is captured and displayed, and the user can check the real space with this video. For example, a virtual object such as an avatar is synthesized into (superimposed over) the video of the real space and displayed. In the optical see-through method, the user can check the real space, which is not video, through lenses arranged to face the eyes of the user. The virtual object is displayed on the lenses, for example. The HMD 100 system is assumed to be the video see-through system. However, the optical see-through system may also be used. The user of the optical see-through HMD may be able to check the displayed avatar as the user (the user's hand, arm, torso, foot, etc.) or may be able to check the user himself/herself that is not video (the avatar of the user does not need to be displayed). The present invention is also applicable to a personal computer connected to the HMD, a gaming machine, a server, and the like.

A retinal projection display that projects images on the retinas of the user may be used instead of the display provided on the back side of the main body unit 101 (the display having a display surface positioned to face the eyes of the user wearing the HMD 100). In the case of the optical see-through system, a projection display that projects images on the lenses positioned to face the eyes of the user may be used.

FIG. 2 is a block diagram illustrating a hardware configuration of the HMD 100. A control unit 201, a memory 202, a non-volatile memory 203, an image/audio processing unit 204, a display 205, an operation unit 206, a storage medium I/F 207, an external I/F 209, and a communication I/F 210 are connected to an internal bus 250. An audio output unit 212 and an orientation detection unit 213 are also connected to the internal bus 250. These are provided in the main body unit 101 illustrated in FIG. 1. The individual units connected to the internal bus 250 can exchange data with each other via the internal bus 250.

The control unit 201 is configured by at least one processor or circuit, and controls the entire HMD 100. The control unit 201 is, for example, a CPU. The memory 202 is, for example, a RAM (a volatile memory using a semiconductor element, etc.). The control unit 201 controls each unit of the HMD 100 by using the memory 202 as a work memory in accordance with a program stored in the non-volatile memory 203, for example. The non-volatile memory 203 stores image data, audio data, other types of data, various programs for operating the control unit 201, etc. The non-volatile memory 203 is a flash memory, a ROM, or the like.

The image/audio processing unit 204 performs various kinds of image processing on images stored in the non-volatile memory 203 or a storage medium 208, images acquired via the external I/F 209, images acquired via the communication I/F 210, and the like, based on the control by the control unit 201. Similarly, the image/audio processing unit 204 performs various kinds of audio processing on audio stored in the non-volatile memory 203 or the storage medium 208, audio acquired via the external I/F 209, audio acquired via the communication I/F 210, etc., based on the control by the control unit 201. The image processing and the audio processing performed by the image/audio processing unit 204 include A/D conversion processing, D/A conversion processing, encoding processing, compression processing, decoding processing, noise reduction processing, etc. The image processing performed by the image/audio processing unit 204 also includes scaling processing (resizing), color conversion processing, etc. The image processing performed by the image/audio processing unit 204 further includes panoramic expansion, mapping processing, conversion processing, etc. of a VR image, which is an omnidirectional image, or if not an omnidirectional image, a wide-range image having data of a wide range. The image/audio processing unit 204 can also perform various kinds of image processing on an image captured by the camera 103 illustrated in FIG. 1. In a case where the HMD 100 includes a microphone or a case where a microphone is connected to the HMD 100, the image/audio processing unit 204 can perform various kinds of audio processing on audio acquired by the microphone. The image/audio processing unit 204 is, for example, a dedicated circuit for performing various kinds of image processing and various kinds of audio processing. The control unit 201 may perform various kinds of image processing and various kinds of audio processing in accordance with a program without using the image/audio processing unit 204.

The display 205 is the above-described display provided on the back side of the main body unit 101 illustrated in FIG. 1, and displays images, a graphical user interface (GUI) screen, or the like based on the control by the control unit 201. The control unit 201 generates a display control signal in accordance with a program and controls the operation of each unit of the HMD 100 so as to generate a video signal for displaying video on the display 205 and input the generated video signal to the display 205. The display 205 displays the video based on the video signal input to the display 205.

The operation unit 206 is an input device for receiving user operations, Examples of the operation unit 206 include a text information input device such as a keyboard, a pointing device such as a mouse, a button, a dial, a joystick, a touch sensor, a touch pad, and the like.

The storage medium I/F 207 is configured such that a storage medium 208 such as a memory card, a CD, or a DVD can be attached in a detachable manner, and performs reading data from and writing data to the attached storage medium 208 based on the control by the control unit 201. The external I/F 209 is an interface for connecting to an external device in a wired or wireless manner and performing input and output of video signals and audio signals to and from the HMD 100. The communication I/F 210 is an interface for communicating with an external device, the Internet 211, etc. and performing transmission and reception of various kinds of data such as files and commands.

The audio output unit 212 outputs audio of moving image data and music data, operation sounds, ringtones, various notification sounds, and the like. The audio output unit 212 includes an audio output terminal for connecting earphones and the like and a speaker. However, the audio output unit 212 may output audio from an external device via wireless communication or the like.

The orientation detection unit 213 detects the orientation (inclination) of the HMD 100 with respect to the gravity direction and the orientation with respect to the yaw, roll, and pitch axes. On the basis of the orientation detected by the orientation detection unit 213, it is possible to determine whether the HMD 100 is held horizontally, held vertically, turned upward, turned downward, inclined, or the like. As the orientation detection unit 213, at least one of an accelerometer, a gyro sensor, a geomagnetic sensor, a direction sensor, an elevation sensor, and the like can be used, or a plurality of sensors may be combined and used.

In the present embodiment, when (virtual) contact between avatars has occurred in a three-dimensional space that is a VR space or an MR space (hereinafter, referred to as an XR space), information (contact information) about the position and intensity of the contact is notified to a contacted user (contacted person). As described above, instead of displaying the avatar, the HMD 100 may display the image of the user himself/herself captured by the camera 103 as the user of the HMD 100. Thus, when viewed from the contacted user, the above-described contact may be contact of the avatar of the contacting user (contacting person) with respect to the contacted user. The contact of the avatar of the contacting user with respect to the contacted user when viewed from the contacted user can be interpreted as the contact of the contacting user with respect to the avatar of the contacted user when viewed from the contacting user.

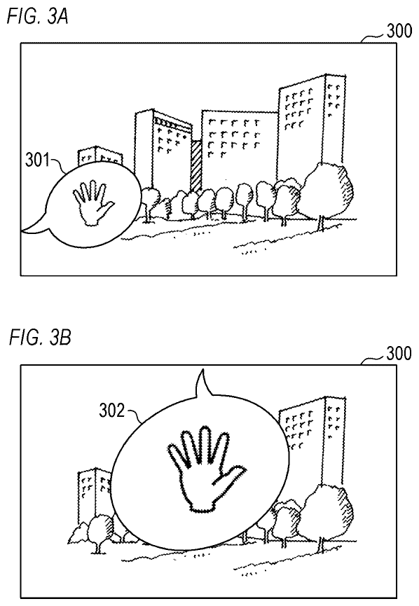

FIGS. 3A and 3B are diagrams schematically illustrating examples of contact information notified to the contacted user. The contacted user is assumed to be a user of the HMD 100. In each of FIGS. 3A and 3B, video of an XR space is displayed on a display surface 300 of the display 205. In FIG. 3A, a notification item 301 superimposed on the video of the XR space is displayed, and in FIG. 3B, a notification item 302 superimposed on the video of the XR space is displayed. The notification items 301 and 302 are displayed when the avatar of the contacting user comes into contact with the avatar of the contacted user. Each of the display positions of the notification items 301 and 302 indicates the position of contact between the avatars, and each of the display sizes of the notification items 301 and 302 indicates the intensity of contact between the avatars. FIG. 3A corresponds to a case where the avatar of the contacting user lightly (softly) comes into contact with the left shoulder of the avatar of the contacted user. Therefore, the notification item 301 is displayed in a small size on the left side. FIG. 3B corresponds to a case where the avatar of the contacting user has strongly come into contact with the head of the avatar of the contacted user (for example, a case where the avatar of the contacting user has strongly hit the head of the avatar of the contacted user). Therefore, the notification item 302 is displayed in a large size on the upper side.

Note that the intensity of the contact does not need to be notified. Further, the contact information may be notified by audio output by using the audio output unit 212, instead of displaying the contact information on the display 205. In this case, for example, the direction of the audio indicates the position of the contact, and the magnitude of the audio (volume of the sound) indicates the intensity of the contact. The contact information may be notified by vibration of the device or the like connected to the external I/F 209 (for example, notification by haptics). In this case, for example, the position of the vibration indicates the position of the contact, and the intensity of the vibration indicates the intensity of the contact. The contact information may be notified by combining two or three notification methods using display, audio, and vibration.

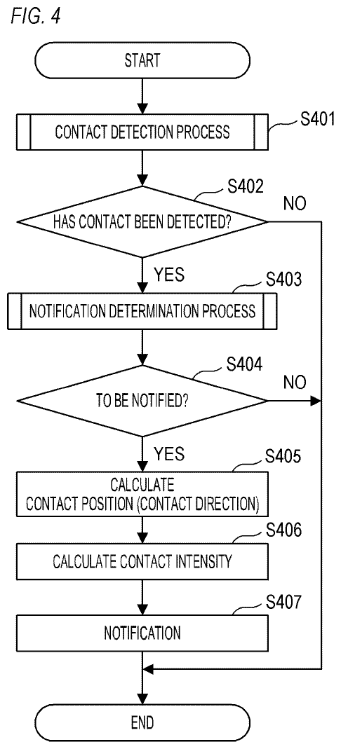

FIG. 4 is a flowchart illustrating a contact notification process performed by the HMD 100. The contact notification process is realized by the control unit 201 loading a program stored in the non-volatile memory 203 into the memory 202 and executing the program. For example, when the user wears and activates the HMD 100, and executes a predetermined application for experiencing the XR space (communication between users in the XR space), the contact notification process is started and repeatedly performed at a predetermined cycle.

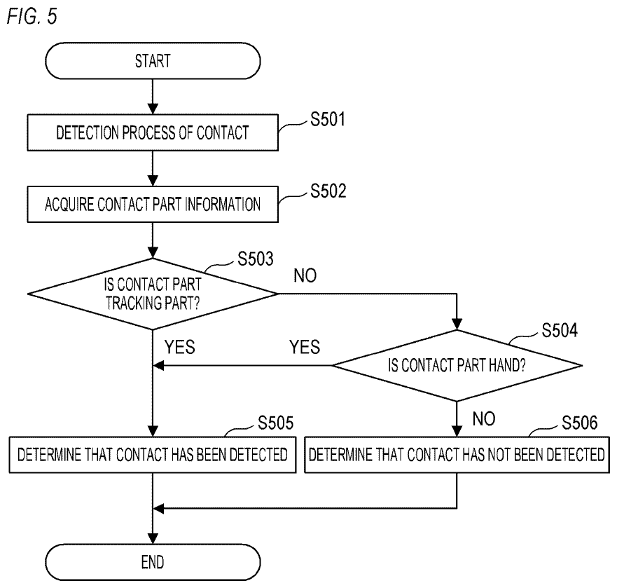

In step S401, the control unit 201 performs the contact detection process for detecting contact between avatars (contact between the avatar of the user of the HMD 100 and the avatar of another user), and stores the result of the contact detection process in the memory 202. The contact detection process will be described in detail below with reference to FIG. 5.

In step S402, the control unit 201 checks the result of the contact detection process stored in the memory 202 (the result of the contact detection process in step S401) and determines whether or not the contact has been detected in step S401. If the contact has been detected, the processing proceeds to step S403, and if not, the contact notification process ends.

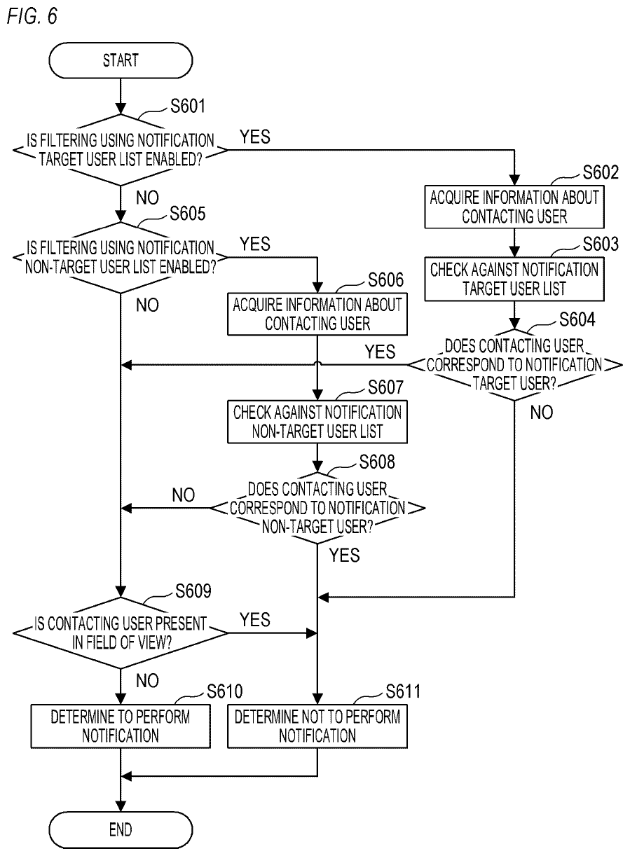

In step S403, the control unit 201 performs a notification determination process for determining whether or not to notify the contact information and stores the result of the notification determination process in the memory 202. The notification determination process will be described in detail below with reference to FIG. 6.

In step S404, the control unit 201 checks the result of the notification determination process stored in the memory 202 (the result of the notification determination process in step S403) and determines whether or not to notify the contact information in accordance with the result. If the contact information is to be notified, the processing proceeds to step S405, and if not, the contact notification process ends.

In step S405, the control unit 201 calculates the direction indicating the position of the contact detected in step S401 in the visual field of the contacted user and stores the calculated direction in the memory 202. The method for calculating the position (direction indicating the position) of the contact is not particularly limited. For example, the position (direction indicating the position) of the contact is calculated on the basis of the location and orientation of the avatar of the contacted user (the user of the HMD 100), the location and orientation of the avatar of the contacting user, and the like. The information about the location and orientation of the avatar of the contacted user is managed by, for example, the HMD 100 (the memory 202) or a server, and the information is acquired from the memory 202 or acquired from the server via the Internet 211. The location and orientation of the avatar of the contacted user are updated by, for example, an action (movement and orientation change) of the contacted user, or a user operation using a controller (not illustrated) of the HMD 100. The location and orientation of the avatar of the contacted user are determined based on, for example, the image capturing result of the camera 103, the detection result of the orientation detection unit 213, or a user operation. The information about the location and orientation of the avatar of the contacting user is acquired from, for example, the server or the HMD of the contacting user via the Internet 211.

In step S406, the control unit 201 calculates the intensity of the contact detected in step S401 and stores the calculated intensity in the memory 202. The method for calculating the intensity of the contact is not particularly limited. For example, the intensity of the contact is calculated based on, for example, the location and orientation of the avatar of the contacted user (the user of the HMD 100), the location and orientation of the avatar of the contacting user, and the like. When the intensity of the contact is calculated, information such as the motion speed of the avatar, the mass (virtual mass) of the avatar, and the mass (virtual mass) of a virtual object possessed by the avatar may be used. The information about the mass of the avatar of the contacted user and the information about the mass of an individual virtual object is managed by, for example, the HMD 100 (memory) or the server, and such information is acquired from the memory 202 or acquired from the server via the Internet 211. The mass of the avatar of the contacted user is registered in advance, for example, in the HMD 100 or the server by the contacted user. The mass of the individual virtual object is determined in advance, for example, when the application for experiencing the XR space is created. The information about the mass of the contacting user is acquired from, for example, the server or the HMD of the contacting user via the Internet 211.

In step S407, the control unit 201 notifies the contacted user (user of the HMD 100) of the information (contact information) about the position and intensity of the contact detected in step S401 based on the calculation results in steps S405 and S406 stored in the memory 202. The notification method is as described above.

Alternatively, at least one of steps S403, S404, and S406 may be omitted. For example, steps S403 and S404 may be omitted, and the processing may proceed from step S402 to step S405 when the contact has been detected. Step S406 may be omitted, and the processing may proceed from step S405 to step S407.

FIG. 5 is a flowchart illustrating the contact detection process (step S401 in FIG. 4). The contact detection processing is realized by the control unit 201 loading a program stored in the non-volatile memory 203 into the memory 202 and executing the program.

In step S501, the control unit 201 performs a detection process for detecting contact of the avatar of another user with respect to the avatar of the user of the HMD 100. The method for the detection process is not particularly limited. For example, contact is detected on the basis of the location and orientation of the avatar of the user of the HMD 100, the location and orientation of the avatar of the other user, and the like. The detection process may be performed by the server or the like. The control unit 201 may acquire the result of the detection process from the server or the like via the Internet 211.

In step S502, the control unit 201 acquires contact part information about a part (contact part) of the other avatar that has come into contact with the avatar of the user of the HMD 100 and stores the acquired contact part information in the memory 202. The contact part is specified (detected) in the above-described detection process, for example. In the present embodiment, the contact part information indicates a contact part and whether or not the contact part is a tracking part (which will be described below). The information about the tracking part is managed by, for example, the HMD 100 (storage medium 208) or the server, and is acquired from the storage medium 208 or acquired from the server via the Internet 211. If the contact is not detected in step S501, the control unit 201 does not acquire contact part information.

The tracking part is a part being tracked, and is also a part whose location is determined on the basis of location information of the controller or the HMD. For example, in a case where a location of the hand of the avatar is determined on the basis of location information of the controller, and a location of the elbow is determined on the basis of the location of the hand, the hand corresponds to a tracking part, and the elbow does not correspond to a tracking part. The tracking device is not limited to the controller or the HMD. For example, the tracking device may be a device worn on an elbow, a shoulder, a knee, a foot, a waist, or the like, and the location of the elbow, the shoulder, the knee, the foot, the waist, or the like of the avatar may be determined on the basis of the location of the corresponding device. Therefore, the elbow, the shoulder, the knee, the foot, the waist, and the like of the avatar could also correspond to tracking parts.

When the avatar can hold a virtual object with a hand, the held virtual object may be regarded as a portion of the hand. Similarly, when the tracking part can hold a virtual object, the held virtual object may be regarded as a portion of the tracking part.

In step S503, the control unit 201 determines whether or not the contact part is a tracking part based on the contact part information (the contact part information acquired in step S502) stored in the memory 202. If the contact part is a tracking part, the processing proceeds to step S505, and if not, the processing proceeds to step S504. If no contact part information has been acquired in step S502 (if no contact has been detected in step S501), the processing proceeds to step S504.

In step S504, the control unit 201 determines whether or not the contact part is a hand based on the contact part information stored in the memory 202 (the contact part information acquired in step S502). If the contact part is a hand, the processing proceeds to step S505, and if not, the processing proceeds to step S506. If no contact part information has been acquired in step S502 (if no contact has been detected in step S501), the processing proceeds to step S506.

In step S505, the control unit 201 stores, in the memory 202, the processing result indicating that the contact of the avatar of the other user with respect to the avatar of the user of the HMD 100 has been detected.

In step S506, the control unit 201 stores, in the memory 202, the processing result indicating that the contact of the avatar of the other user with respect to the avatar of the user of the HMD 100 has not been detected.

Alternatively, at least one of steps S502 to S504 and S506 may be omitted. For example, the processing may proceed from step S502 to step S504 without performing step S503. Step S504 may be omitted, and the processing may proceed from step S503 to step S506 when the contact part is not a tracking part. Steps S502 to S504 and S506 may be omitted, and the processing may proceed from step S501 to step S505.

FIG. 6 is a flowchart illustrating the notification determination process (step S403 in FIG. 4). The notification determination process is realized by the control unit 201 loading a program stored in the non-volatile memory 203 into the memory 202 and executing the program.

In step S601, the control unit 201 determines whether or not filtering using a notification target user list is enabled. If the filtering is enabled, the processing proceeds to step S602, and if not, the processing proceeds to step S605. The notification target user list is a list indicating users (notification target users) to whom contact information is to be notified. Information about the setting (enabled/disabled) of the filtering using the notification target user list is managed by, for example, the HMD 100 (the memory 202 or the storage medium 208) or the server. Therefore, the information about the setting of the filtering using the notification target user list is acquired from the memory 202, acquired from the storage medium 208, or acquire from the server via the Internet 211.

In step S602, the control unit 201 acquires user information about the contacting user from the server, the HMD of the contacting user, or the like via the Internet 211 and stores the acquired user information in the memory 202. The user information of the contacting user includes, for example, information indicating the contacting user (ID information for identifying the contacting user, etc.).

In step S603, the control unit 201 acquires the notification target user list and checks the user information of the contacting user against the notification target user list. The notification target user list is managed by, for example, the HMD 100 (storage medium 208) or the server, and is acquired from the storage medium 208 or acquired from the server via the Internet 211.

In step S604, the control unit 201 determines whether or not the contacting user corresponds to a notification target user. If the contacting user corresponds to a notification target user, the processing proceeds to step S609, and if not, the processing proceeds to step S611.

In step S605, the control unit 201 determines whether or not filtering using a notification non-target user list is enabled. If the notification non-target user list is enabled, the processing proceeds to step S606, and if not, the processing proceeds to step S609. The notification non-target user list is a list indicating users (notification non-target users) who are not to be notified of the contact information. Information about the setting (enabled/disabled) of the filtering using the notification non-target user list is managed by, for example, the HMD 100 (the memory 202 or the storage medium 208) or the server. Therefore, the information of the setting of the filtering using the notification non-target user list is acquired from the memory 202, acquired from the storage medium 208, or acquired from the server via the Internet 211.

In step S606, the control unit 201 acquires the user information about the contacting user from the server, the HMD of the contacting user, or the like via the Internet 211, and stores the acquired user information in the memory 202.

In step S607, the control unit 201 acquires the notification non-target user list and checks the user information about the contacting user against the notification non-target user list. The notification non-target user list is managed by, for example, the HMD 100 (storage medium 208) or the server, and is acquired from the storage medium 208 or acquired from the server via the Internet 211.

In step S608, the control unit 201 determines whether or not the contacting user corresponds to a notification non-target user. If the contacting user corresponds to a notification non-target user, the processing proceeds to step S611, and if not, the processing proceeds to step S609.

In step S609, the control unit 201 determines whether or not the avatar of the contacting user is present in the field of view of the contacted user (the user of the HMD 100). If the avatar of the contacting user is present in the field of view, the processing proceeds to step S611, and if not, the processing proceeds to step S610. The determination method for step S609 is not particularly limited. For example, the control unit 201 may determine whether or not the avatar of the contacting user is present in the field of view based on a video signal (information used for generating a video signal) for displaying video on the display 205. The control unit 201 may determine whether or not the avatar of the contacting user is present in the field of view based on the location and orientation of the avatar of the contacted user, the location and orientation of the avatar of the contacting user, or the like.

In step S610, the control unit 201 stores, in the memory 202, the determination result indicating that the contact information is to be notified.

In step S611, the control unit 201 stores, in the memory 202, the determination result indicating that the contact information is not to be notified.

Alternatively, at least one of steps S601 to S609 may be omitted. For example, steps S601 to S604 may be omitted, and step S605 may be performed as the first step. Steps S605 to S608 may be omitted, and the processing may proceed from step S601 to step S609 when the filtering with the notification target user list is disabled. Steps S601 to S608 may be omitted, and step S609 may be performed as the first step. Step S609 may be omitted, and when the contacting user corresponds to the notification target user, when the filtering with the notification non-target user list is disabled, and when the contacting user corresponds to the notification non-target user, the processing in step S610 may be performed. When the filtering with the notification target user list is disabled, the processing in step S610 may be performed.

According to the present embodiment described above, when virtual contact of one user with respect to another user in the VR or MR space is detected and the virtual contact has occurred, the user who is the contacted person is notified of information about the position of the contact. This makes it possible to utilize virtual contact between users, such as contact between avatars, as a sufficient communication tool. For example, the contacted person can grasp the position on which the contacted person has been touched and can react naturally to the contact by looking at the direction of the contact. For example, the contacted person can turn to the right if the contacted person has been touched on the right shoulder (from behind), or turn to the left if the contacted person has been touched on the left shoulder (from behind).

Furthermore, according to the present embodiment, the contacted person is notified of information about not only the position of the contact but also the intensity of the contact. This allows the contacted person to react more naturally to the contact by, for example, not noticing when the intensity of the contact is weak or being surprised when the intensity of the contact is strong.

The above-described embodiment (including modifications) is merely an example, and configurations obtained by appropriately modifying or changing the configuration of the above-described embodiment within the scope of the gist of the present invention are also included in the present invention. Configurations obtained by appropriately combining the configurations of the above-described embodiment are also included in the present invention.

For example, although the example in which virtual contact is detected on the side of the contacted person (the HMD of the contacted person) has been described, the present invention is not limited thereto. For example, virtual contact may be detected on the side of the contacting person (the HMD of the contacting person), and the detection result of the virtual contact may be notified from the contacting person side to the contacted person side. In this case, the notification of the detection result (information) indicating that the virtual contact has occurred on the contacting person side can be interpreted as a control operation of notifying the contacted person of information about the position of the virtual contact. Thus, the information processing apparatus to which the present invention is applicable is not limited to the apparatus on the contacted person side but may be the apparatus on the contacting person side. The information processing apparatus to which the present invention is applicable may be a server. Note that, on the contacted person side, the acquisition of the detection result (information) indicating that virtual contact has occurred can be interpreted as the detection of the virtual contact.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-087774, filed on May 29, 2023, which is hereby incorporated by reference herein in its entirety.

What is claimed is:

1. An information processing apparatus comprising:
a processor; and
a memory storing a program which, when executed by the processor, causes the processor to
detect virtual contact of a second user with respect to a first user in a three-dimensional space that is a virtual space or a mixed reality space; and
perform control such that, in a case where the virtual contact has occurred, the first user is notified of information about a position of the contact.

2. The information processing apparatus according to claim 1, wherein
it is detected contact of an avatar of the second user with respect to the first user in the three-dimensional space that is the mixed reality space.

3. The information processing apparatus according to claim 1, wherein
it is detected contact of an avatar of the second user with respect to an avatar of the first user in the three-dimensional space that is the virtual space.

4. The information processing apparatus according to claim 1, wherein
the control is performed such that the information about the position and intensity of the contact is notified.

5. The information processing apparatus according to claim 1, wherein
the control is performed such that the information is notified by display or audio.

6. The information processing apparatus according to claim 1, wherein
the control is performed such that the information is notified by vibration.

7. The information processing apparatus according to claim 1, wherein
in a case where the second user is not included in a first list, the information is not notified.

8. The information processing apparatus according to claim 1, wherein
in a case where the second user is included in a second list, the information is not notified.

9. The information processing apparatus according to claim 1, wherein
in a case where the second user is present in a field of view of the first user in the three-dimensional space, the information is not notified.

10. The information processing apparatus according to claim 1, wherein
it is detected contact of a hand of the second user with respect to the first user.

11. The information processing apparatus according to claim 1, wherein
at least a portion of a plurality of parts of the second user is tracked, and
it is detected virtual contact of a tracked part among the plurality of parts of the second user with respect to the first user.

12. The information processing apparatus according to claim 1, wherein
it is detected contact of a virtual object held by the second user with respect to the first user.

13. A control method of an information processing apparatus, comprising:
detecting virtual contact of a second user with respect to a first user in a three-dimensional space that is a virtual space or a mixed reality space; and
performing control such that, in a case where the virtual contact has occurred, the first user is notified of information about a position of the contact.

14. A non-transitory computer readable medium that stores a program, wherein the program causes a computer to execute a control method of an information processing apparatus, the control method comprising:
detecting virtual contact of a second user with respect to a first user in a three-dimensional space that is a virtual space or a mixed reality space; and
performing control such that, in a case where the virtual contact has occurred, the first user is notified of information about a position of the contact.
